(19) United States
(12) Patent Application Publication
(10) Pub. No.: US 2018/0212958 A1
(43) Pub. Date: Jul. 26, 2018

(54) Two Factor Authentication Using SMS

(71) Applicant: TelTech Systems, Inc., South Amboy, NJ (US)

(72) Inventor: Meir Feigin Cohen, South Amboy, NJ (US)

(21) Appl. No.: 15/824,113

(22) Filed: Nov. 28, 2017

Related U.S. Application Data
(60) Provisional application No. 62/450,854, filed on Jan. 26, 2017.

(51) Int. Cl. H04L 29/06; G06F 17/30; H04W 4/12; H04L 29/08; H04M 1/725

(52) U.S. Cl. CPC H04L 63/0853; H04L 63/18; G06F 17/3043; G06F 21/31; H04W 4/12; H04L 67/02; H04M 1/72522; G06F 17/30861

(57) ABSTRACT

Authentication of a user and/or granting of access to secure data is made by way of an out of bounds authentication of the user by having the user use a different device, protocol, and/or network channel to communicate an answer to a challenge question posed to the user. The user request for data can be in a web browser on a first device. In one embodiment, a challenge question is then sent to the user via SMS on a phone. However, the answer to the challenge question must be received via the web browser to prevent a man in the middle attack. In another embodiment, the challenge question is sent to the web browser but the answer must be received via SMS. Neither device sends or receives both the challenge question and answer. Interception of one of these communications is insufficient, in embodiments, for identity theft or a man-in-the-middle attack.

### FIELD OF THE DISCLOSED TECHNOLOGY

The disclosed technology relates generally to telephone switches and, more specifically, to customized call routing.

### BACKGROUND

Two factor authentication is a method of confirming a user's claimed identity by utilizing a combination of two different components. Mobile phone two-factor authentication works by sending a one time code or other indicia to a mobile phone associated with a user. This is typically done by SMS (short message service) or a data connection to the phone. This allows authentication without a user carrying a dongle or other device which outputs a code. A drawback to this method, however, is that the code can be intercepted by a party in the middle. Thus, this method lacks the security of, for example, a standalone dongle which generates different codes over different times.

Borrowing from the Wikipedia article entitled “Man-in-the-middle attack,” an attacker can make two parties believe they are directly communication with each other when, in fact, the man in the middle, is steering the conversation between each party. For example, an attacker within reception range of an unencrypted wireless access point (Wi-Fi) can insert himself as a man-in-the-middle. A notable non-cryptographic man-in-the-middle attack was perpetrated by a Belkin wireless network router in 2003. Periodically, it would take over an HTTP connection being routed through it: this would fail to pass the traffic on to destination, but instead itself respond as the intended server. The reply it sent, in place of the web page the user had requested, was an advertisement for another Belkin product. After an outcry from technically literate users, this ‘feature’ was removed from later versions of the router's firmware. In 2011, a security breach of the Dutch certificate authority DigiNotar resulted in the fraudulent issuing of certificates. Subsequently, the fraudulent certificates were used to perform man-in-the-middle attacks. In 2013, the Nokia's Xpress Browser was revealed to be decrypting HTTPS traffic on Nokia's proxy servers, giving the company clear text access to its customers' encrypted browser traffic.

Recently, Google has started providing physical hardware keys (USB or Bluetooth) for “high risk users.” The users must have the physical security key to gain access to a device in order to prevent man in the middle attacks, identity theft, and the like. While this method works, it is inconvenient and expensive compared to using the hardware already on user devices. Thus, while methodologies exist to prevent man in the middle and other sorts of attacks, the need still exists to provide simple, cost efficient, prevention of man in the middle and other sorts of spoofing attacks and personal identity theft known in the art.

### SUMMARY OF THE DISCLOSED TECHNOLOGY

In embodiments of the disclosed technology, a user desires to gain access to secure information. This can include bank account information, email, or any information where it is desired to ensure that the data is sent only to the correct recipient. Thus, the user is authenticated by communicating with two of his or her devices to verify that the user is who they say they are. One of the novel features of the present technology is that a question or prompt for data is posed to one of the devices while the user must answer from the other device, the answering device never having received the question or prompt (herein, “challenge question”) avoiding a man in the middle type attack known in the prior art.

This is carried out by receiving a request to access data via a first network protocol (e.g. HTTP or HTTPS (herein, “hypertext transport protocol” which, for purposes of this disclosure includes “hypertext transport protocol secure”) from a first physical hardware device (e.g. via a first antenna or a via a first distinct device in it's own housing). A challenge question is then sent via the first network protocol to the first physical hardware device. A request to answer the challenge question is send to the second physical hardware device via a different network protocol and the answer is received over this second network protocol. In one example, the user desires access on his desktop computer to a restricted part of a website and the user is prompted with a question, but must answer via short message service (SMS) from his cellular phone. The desktop computer is communicating via HTTPS through TCP/IP gateways (transport control protocol, Internet protocol) while the answer is received via a cellular network communicating through a protocol such as the global system for mobile communication (GSM) protocol and it's successors (e.g. 3GPP). The challenge question, in embodiments of the disclosed technology, is not sent to the device from which the answer must be received for the specific challenge question. That is, in embodiments of the disclosed technology, the request to answer the challenge question is sent to a device without actually sending the challenge question and/or the answer is received from a device which has neither been prompted to answer nor given the question to be answered.

The challenge question can be sent to a device on which the user desires to gain the access to further data, in which case, the answer is received from a second physical hardware device. Or, alternatively, the device on which the challenge question is sent and the answer is received can be reversed. In such a case, the challenge question is sent to a different hardware device associated with the user than the on or through which the user desires to gain access to further data. Then, then answer to the challenge question is received from the device on which the user desires to, and is granted access or sent data which was previously unaccessible to the user.

This can be carried out where the first hardware device is a hardware device with a web browser, such as what is commonly referred to as a desktop or laptop computer communicating via a packet-switched TCP/IP network (commonly referred to as, “the Internet”) while the second hardware device is communicating via a cellular data network between a phone (portable device which has a dedicated phone number on the PSTN (public switched telephone network)) and a cellular tower.

Described another way, a system for authenticating a user of embodiments of the disclosed technology can be used to grant a user access to secure information or data which otherwise would be withheld from the user. In order to do so, the system communicates with two devices of the user, a first and second hardware device. Each is communicated with via a different network node and/or an entirely different network protocol. In this manner, a hacker is inhibited from gaining access/pretending to be the user in question because they would need to be able to simultaneously access not one, but two different networks, each of which receive mutually exclusive data. It is the user who must receive the data from one network, and then respond appropriately on the other network while the question posed or information sufficient to direct a user to provide an appropriate response (referred to as a “challenge question” in the claims) is sent on one network node and/or network protocol while the response must be sent via a second network node and/or network protocol.

Thus, the system receives from the first hardware device a request to access content, sends a challenge question to the user via one of said first network node or the second network node, and receives an answer to the challenge question via a network node other than the one in which the challenge question was sent. Only then is data sent to the first hardware device which includes the content requested.

The hardware devices described can include two physically separated devices in two different housings. This is defined as two devices which function independently of one another and lack direct network connectivity to each other. Such two different devices, in some embodiments, are incapable of communicating with each other in a way in which the challenge question could be received and answered due to lack of a common mechanism of connecting the devices. For example, a cellular phone, at the time of this writing, can typically only connect to a desktop computer (one without a wireless receiver) via the USB (universal serial bus) protocol, but such a connection would be insufficient, in many cases and for most users other than the most sophisticated, for receiving the contents of the SMS message sent to the phone to the desktop computer where the challenge question is answered.

Alternatively, the first hardware device and the second hardware device can be different antennas in a same housing (e.g. one antenna for receiving/sending cellular data and another for receiving/sending local area network (LAN) data such as over a Wi-Fi network (e.g. an 802.11-based network, known in the art). One protocol used can be designed for a web browser (e.g. HTTP or HTTPS) while the other can be designed for sending and receiving of text messages (e.g. short message service or “SMS”). The answer to the challenge question, in embodiments of the disclosed technology, is received only from a device which has not received the challenge question.

Any device or step to a method described in this disclosure can comprise or consist of that which it is a part of, or the parts which make up the device or step. The term “and/or” is inclusive of the items which it joins linguistically and each item by itself.

### BRIEF DESCRIPTION OF THE DRAWINGS

FIG. 1 shows a high level block diagrams of devices used to carry out embodiments of the disclosed technology with the challenge question posed to a device where secure access is granted.

FIG. 2 shows a high level block diagrams of devices used to carry out embodiments of the disclosed technology with the challenge question posed to a different device than a device where secure access is granted.

FIG. 3 shows a flow diagram of devices of embodiments of the disclosed technology communicating to grant access where the challenge question is posed to a device seeking restricted access.

FIG. 4 shows a flow diagram of devices of embodiments of the disclosed technology communicating to grant access where the challenge question is posed to a device other than one seeking restricted access.

FIG. 5 shows a flow chart of steps taken to grant secure access by way of receiving a challenge answer from a second device in an embodiment of the disclosed technology.

FIG. 6 shows a flow chart of steps taken to grant secure access by way of sending a challenge question to a second device in an embodiment of the disclosed technology.

FIG. 7 shows a high level block diagram of devices used in embodiments of the disclosed technology.

### DETAILED DESCRIPTION OF EMBODIMENTS OF THE DISCLOSED TECHNOLOGY

Authentication of a user and/or granting of access to secure data is made by way of an out of bounds authentication of the user by having the user use a different device, protocol, and/or network channel to communicate an answer to a challenge question posed to the user. The user request for data can be in a web browser on a first device. In one embodiment, a challenge question is then sent to the user via SMS on a phone. However, the answer to the challenge question must be received via the web browser to prevent a man in the middle attack. In another embodiment, the challenge question is sent to the web browser but the answer must be received via SMS. Neither device sends or receives both the challenge question and answer. Interception of one of these communications is insufficient, in embodiments, for identity theft or a man-in-the-middle attack.

Embodiments of the disclosed technology are described below, with reference to the figures provided.

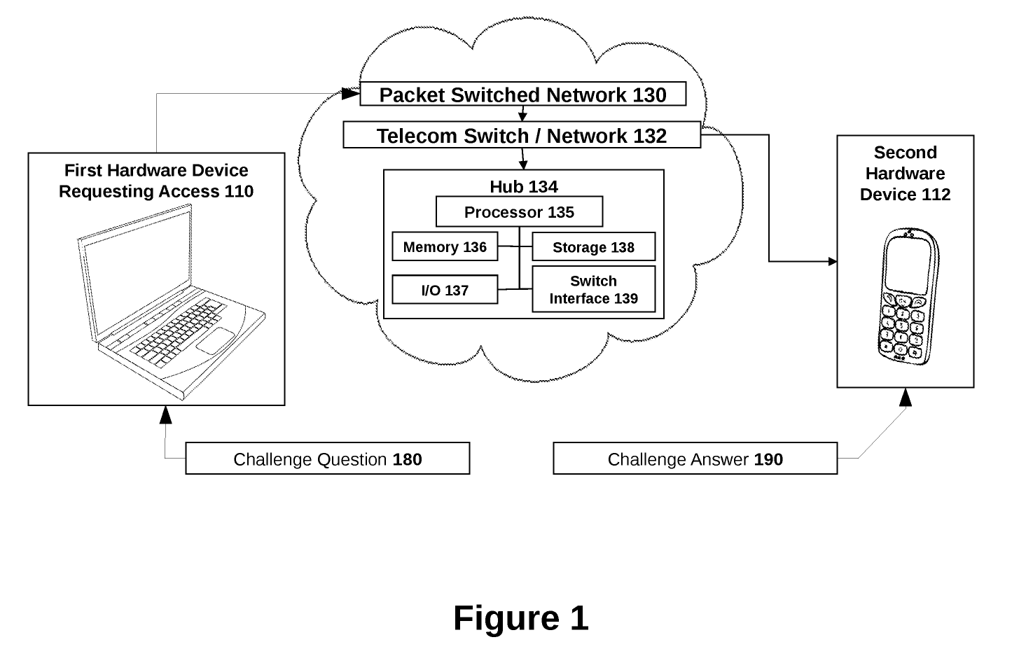

FIG. 1 shows a high level block diagrams of devices used to carry out embodiments of the disclosed technology with the challenge question posed to a device where secure access is granted. A first hardware device 110 has a network connection to a packet switched network 130 (e.g. the global network of packet-switched routers, hubs, switches, and nodes used to transport data to each other by the TCP/IP protocol known as “the Internet”). Through the packet switched network 130, in this example, the device 110 sends a request to gain access to (receive) data which requires authentication as to the identity of the user of the hardware device 110. A transmitter/receiver can be used to enables wireless transmission and receipt of data via the packet-switched network 130, such as by way of the 802.11 wireless transmission protocols known in the art. Alternatively, a wired connection such as via category 5 or 6 cable can be used.

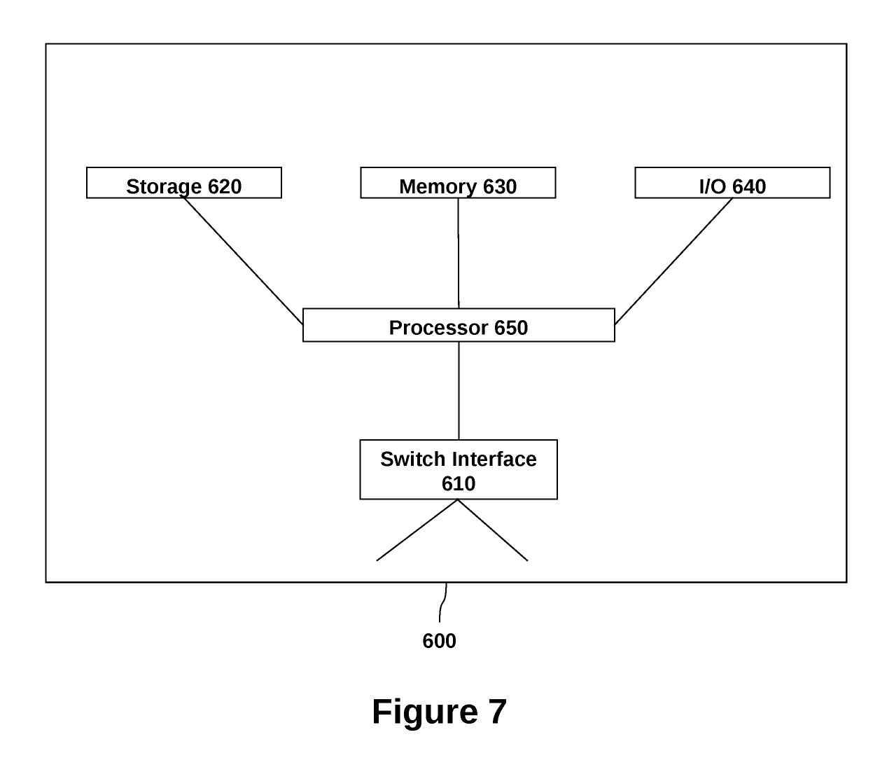

This network, in embodiments, interfaces with a telecommunications switch 132 and/or a server (another hardware device or multiple different hardware devices, such as described with reference to FIG. 7) receives communications from the packeted switched network 130 and a telecom network or switch 132. Versions of these data, which include portions thereof, can be transmitted between the devices. A “version” of data is that which has some of the identifying or salient information as understood by a device receiving the information.

Referring again to the telecommunications switch 132, this switch interfaces with the PSTN or another telephone network including a GSM network, SMS network, or another network or protocol defined for use with phones and/or phone service. Such phone and/or phone service is a distinctly different network than the packet switched network 130, though data from one network can and sometimes is carried via the other network (e.g. a TCP/IP connection by way of an analog modem or a phone connection carried via a packet switched network). For purposes of this disclosure, in some embodiments of the disclosed technology, at least the protocol used to communicate between the second hardware device 112 and the telecom switch is a different protocol than the one between the first hardware device 110 and the packet switched network 130 making identity theft or the like more difficult. In some embodiments, not only is the protocol different but so is at least some or all of the network nodes and hardware switches that the data is transported over between the hardware device and respective network.

Each device shown in FIG. 1 represents a device and node where data are received and transmitted to another device via electronic or wireless transmission, Each can be connected to, or communicate via, a hub 134, such as operated by an entity controlling the methods of use of the technology disclosed herein. This hub has a processor 135 which processes data sent and received to the end user hardware devices 110 and 112 and determines when security credentials have been met to grant access to data otherwise unavailable to one or both end user devices 110 and 112. This hub 134 further has memory 136 (volatile or non-volatile) for temporary storage of data, storage 138 for permanent storage of data, and input/output 137 (like the input/output 124), and an interface 139 for connecting via electrical connection to other devices.

Still discussing FIG. 1, after the first hardware device 110 requests access to secure data or data which requires authentication, a challenge question 180 is sent to the device. However, to prevent identity theft and man in the middle attacks, the answer to this question is provided via the other second hardware device 112 as seen in block 190 in FIG. 1. In this manner, one intercepting the data between the device 110 and the hub 134 anywhere on the packet switched network 130, even if the communication is completely unencrypted, will not receive the challenge answer 190. So too, one intercepting the communication between the second hardware device 112 and the telephone switch 132 or hub 134 will only have the challenge answer 190 but not know what the question was. For example, one might request access to their bank account data from their laptop 110, the request send via the HTTP protocol over the packet switched network 130. The challenge question is then sent to be displayed on the first hardware device's display.

Such a challenge question might be, “What is 2+2?”, “Enter the number 5280”, “What is your mother's maiden name?”, or “What color is this picture of a car?” Then the user might receive a text message to their second hardware device 112, “What's the answer?” or be given instructions on their device 110 stating, “Text your answer to 973-555-1212 from your cellular phone ending in 5280.” This answer would be the challenge answer 190. Thus, the challenge question and answer are divorced from each other, being sent and received on different devices using different communication channels.

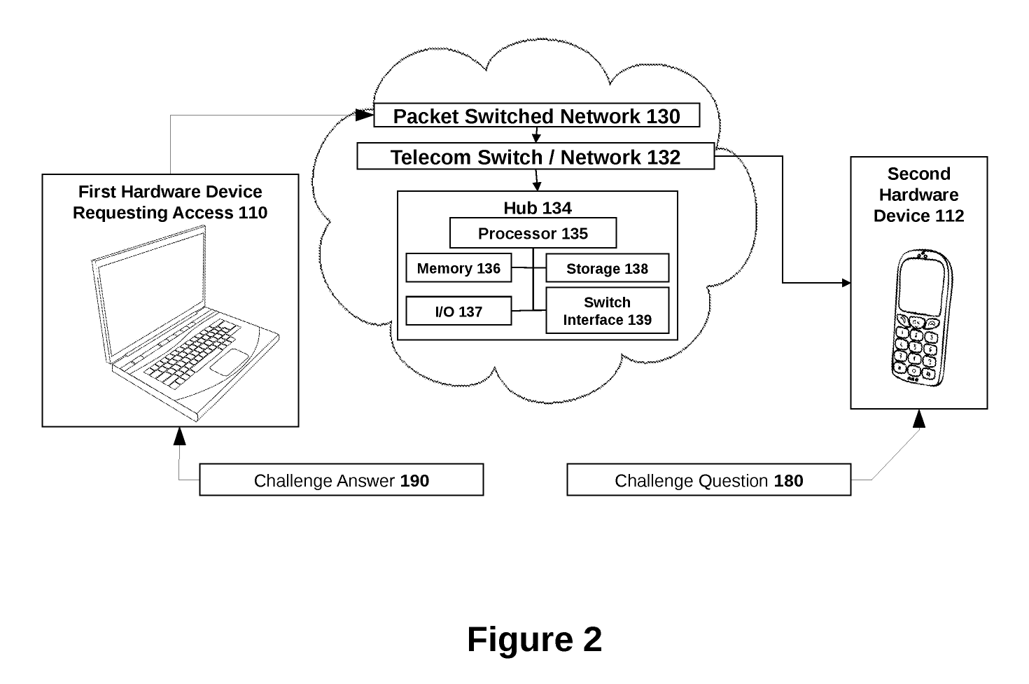

FIG. 2 shows a diagram of devices used to carry out steps of the disclosed technology. The bi-directional transceiver 110 is the device associated with a calling party, which, in step 205 initiates a call to the bi-directional transceiver 112. This call is received by the bi-directional transceiver 112 and rings to this device. The called party (operator of the bi-directional transceiver 112) then rejects the call in step 210, causing it to be forwarded to another phone line, such as a forwarding to voicemail. This rejected call is received at a hub 134 (located on the data and/or telecom network) which then ascertains data about the calling party. This is accomplished by forwarding the call in step 215 to an inward WATS telephone number, in some embodiments. The Inward WATS telephone number reports on the ANI information and sends it back to the hub 134 in step 220. In addition, or instead, the hub 134 conducts a database lookup of the phone number, user identification, name, or location of the calling party reported through any of the prior steps described, or data provided by the device of the calling party at the time of the call. These received data, which can include a name, picture, profile of a social media account (or data stored-therein) is sent back to the hub in step 230.

FIG. 2 shows a high level block diagrams of devices used to carry out embodiments of the disclosed technology with the challenge question posed to a different device than a device where secure access is granted. In this embodiment, the elements shown as the same as in FIG. 1 except that the challenge question and answer are inverted. Thus, the challenge question 180 is posed to the second hardware device 112, a device other than the one from which a request to access authenticated data was sent. The answer 190 is provided on the device which did request the access, device 110. In some embodiments, the access is granted on device 112 and in others, the access is granted in device 110. In yet another embodiment, the access to the secure or authenticated data is provided to both devices. In any case, in this scenario, the hardware device 110 requests access (e.g. an attempt to login to view bank records for a particular person). The second hardware device 112 (e.g. a cellular phone associated with the user) is sent a challenge question 180, such as one of the examples described with reference to FIG. 1. The challenge question 180 might be the question alone without instructions on how to respond or where to respond. Thus, a text message received might simply say, “What color is the image of the dog you see on your screen?” or “What's 2×22?”. Meanwhile, the instructions on how/where to answer are displayed on the screen of the first hardware device 110 requesting access and the answer 190 is inputted into this device 110. Again, the question and answer are divorced from each other and sent via partially, mostly, or completely different network protocols, network routes between hubs and switches, and/or end user devices.

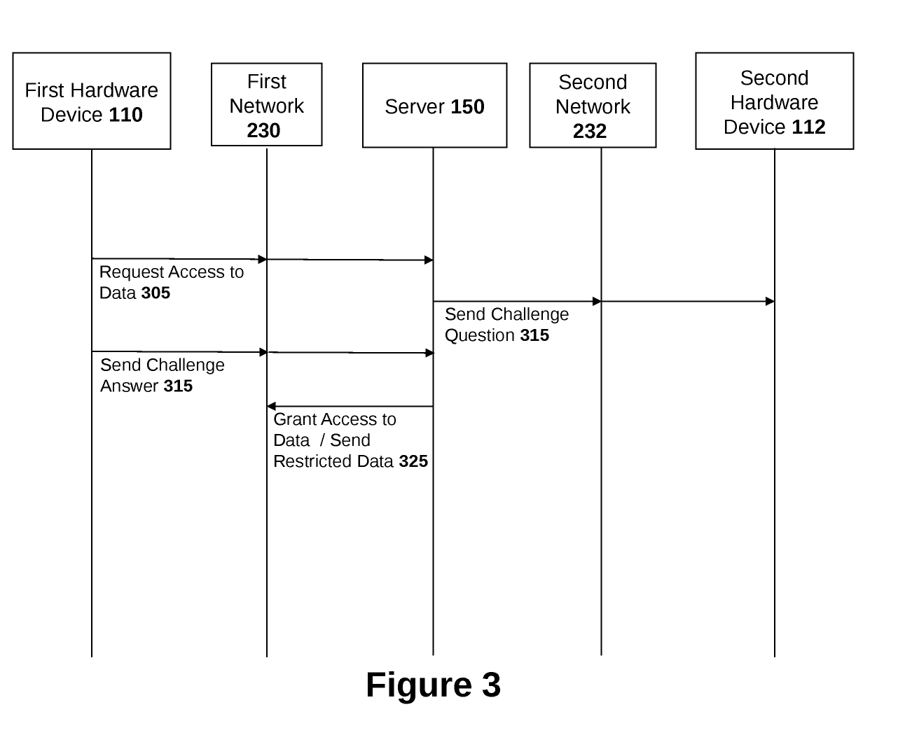

FIG. 3 shows a flow diagram of devices of embodiments of the disclosed technology communicating to grant access where the challenge question is posed to a device seeking restricted access. The first and second hardware devices 110 and 112 are as shown and described with reference to FIGS. 1 and 2. The first network 230 is a network with a specific protocol and/or specific hardware hubs, switches, and/or routers over which data is communicated between the first hardware device 110 and server 150. The second network 232 is a second network with one or more of a second specific protocol and/or specific hardware hubs, switches, and/or routers over which data is communicated between the second hardware device 112 and server 150. Thus, one network can be a network of cellular phone towers and a GSM or 3GPP-based communications protocol and the other can be a network of hardware devices communicating using internet protocol addresses and TCP/IP.

In step 305, access is requested to specific data, such as secure data or data which requires authentication of a user's identity. This request is made by way of the first hardware device, the request or a version thereof being transmitted over the first network 230 to the server 150. The server 150 is a device or a plurality of devices, such as shown in FIG. 1 or 7, which can be a hub and makes a decision to grant the access to the requested data. The server 150 sends, or causes to be sent (the preceding terminology is equivalent, for purposes of this disclosure), a challenge question in step 315 to the second hardware device 112 by way of the second network 232. In this embodiment, the challenge question sending in step 315 is the only communication in either direction between the server 150 and the second hardware device. In response, the answer to the challenge question, in step 315, is send from the first hardware device 110 to the server 150, again via the first network 230. The server then grants access, or causes access to be granted, to the first hardware device to the requested data, in step 325. The first hardware device can now access the secure data after this authentication.

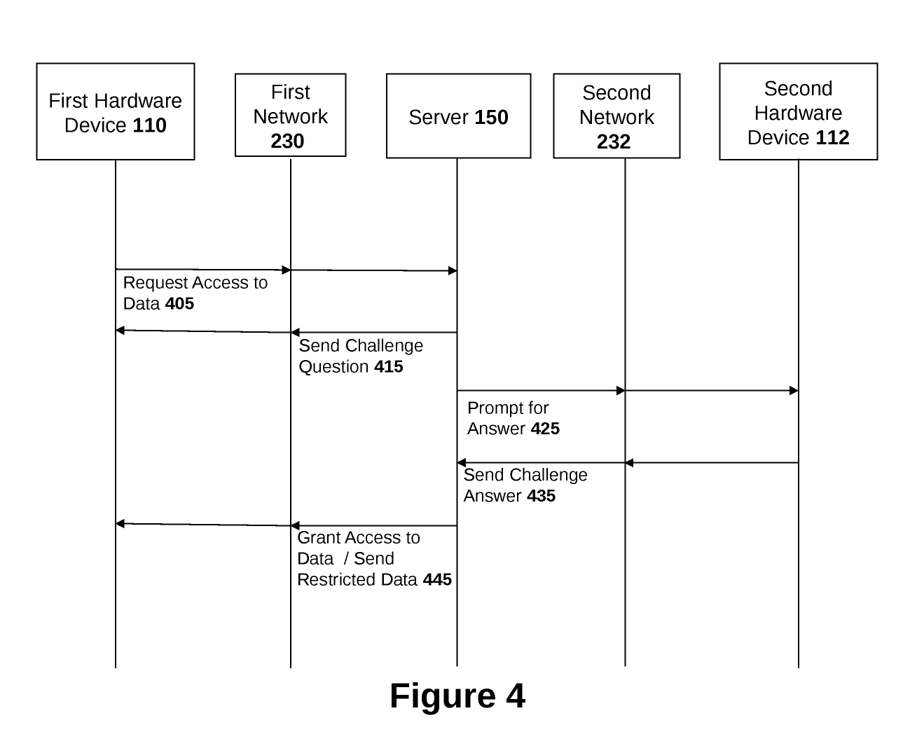

FIG. 4 shows a flow diagram of devices of embodiments of the disclosed technology communicating to grant access where the challenge question is posed to a device other than one seeking restricted access. In this embodiment step 405 is analogous to step 305 of FIG. 3. The devices 110, 112, 150, 230, and 232 shown in FIG. 4 and identical to those described with reference to FIG. 3. However, in step 415 the challenge question is sent to the first hardware device 110 which requested the access. In optional step 425, a prompt for the answer is second to a second hardware device 112. Whether or not the prompt for the answer (without revealing the question) is sent to the second hardware device 112, the second hardware device must, in step 435, send back an answer to the challenge question via the second network 232. An owner of the second hardware device 112 would know, in embodiments of the disclosed technology, to send the answer based on a challenge question being exhibited on the first hardware device 110. This is assuming the first and second hardware devices are located with the same user, in embodiments of the disclosed technology. Upon a determination that a proper answer to the challenge question has been received from the second hardware device, in step 445 the server 150 (e.g. a hub) grants access to restricted data and/or considers the user of the first hardware device 110 to have been authenticated.

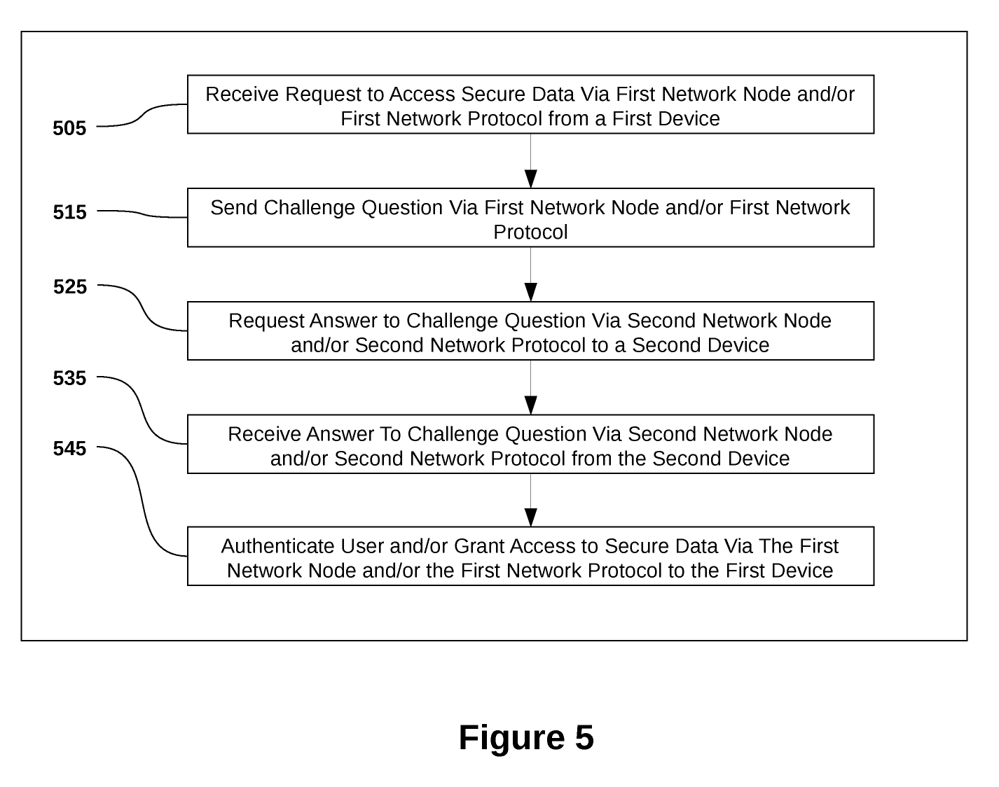

FIG. 5 shows a flow chart of steps taken to grant secure access by way of receiving a challenge answer from a second device in an embodiment of the disclosed technology. In step 505, a request is received to access secure data via a first network node and/or a first network protocol from a first distinct hardware device. The challenge question is sent, in step 515, via the same network node and/or protocol, but the answer, in step 535 must be sent via a second distinct network node and/or network protocol from a second device based on a query for same which was made is step 525. Only once a correct answer is received from the second device via the second network node and/or by way of using a different network protocol in step 535, is the user authenticated, in step 545, or granted access to secure data. This access is given via the first network node and/or first network protocol to the first network devices in embodiments of the disclosed technology. The term, “network protocol” is defined as, “a pre-defined methodology for exchanging data in a way that a sending device and recipient device can carry out instructions or make meaningful use of the data beyond simply receiving/sending the data over an electronic network communication channel between the two devices”.

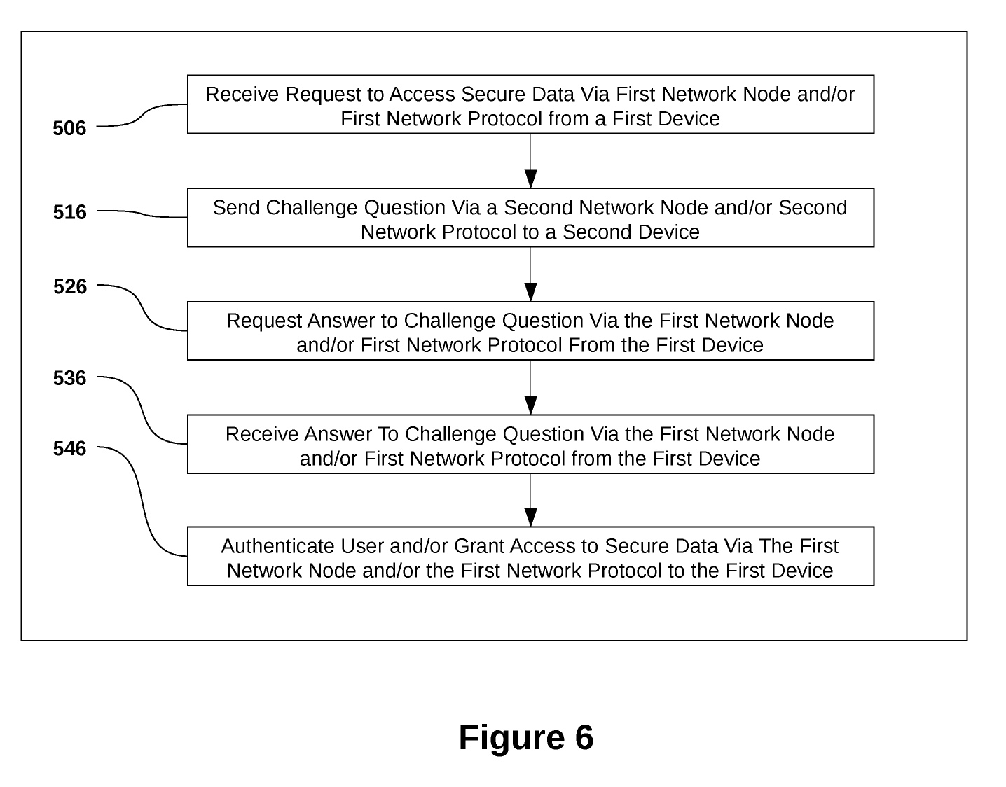

FIG. 6 shows a flow chart of steps taken to grant secure access by way of sending a challenge question to a second device in an embodiment of the disclosed technology. Here, steps 505 (from FIG. 5) is analogous to step 506. In step 516, the challenge question is sent to the second device via it's respective network node and/or network protocol. The first and second devices, in some embodiments are the same hardware device using two different hardware antennas. In some embodiments, the devices are two physically separate and uncoupled devices separately transportable and usable without one another to carry out various functions. The answer is requested, in step 525, not from the second device, but from or via the first device using it's associated network or protocol, e.g. the same network or protocol over which the initial request for access was made. Once the answer is received in step 536 via the first network node/protocol and/or device, then in step 546 the user is considered authenticated and/or granted access to the secure data which was requested.

FIG. 7 shows a high level block diagram of devices used in embodiments of the disclosed technology. Device 600 comprises a processor 650 that controls the overall operation of the computer by executing the device's program instructions which define such operation. The device's program instructions may be stored in a storage device 620 (e.g., magnetic disk, database) and loaded into memory 630 when execution of the console's program instructions is desired. Thus, the device's operation will be defined by the device's program instructions stored in memory 630 and/or storage 620, and the console will be controlled by processor 650 executing the console's program instructions. A device 600 also includes one, or a plurality of, input network interfaces for communicating with other devices via a network (e.g., the internet). The device 600 further includes an electrical input interface. A device 600 also includes one or more output network interfaces 610 for communicating with other devices. Device 600 also includes input/output 640 representing devices, which allow for user interaction with a computer (e.g., display, keyboard, mouse, speakers, buttons, etc.). One skilled in the art will recognize that an implementation of an actual device will contain other components as well, and that FIG. 6 is a high level representation of some of the components of such a device, for illustrative purposes. It should also be understood by one skilled in the art that the method and devices depicted in FIGS. 1 through 6 may be implemented on a device such as is shown in FIG. 7.

Further, it should be understood that all subject matter disclosed herein is directed at, and should be read only on, statutory, non-abstract subject matter. All terminology should be read to include only the portions of the definitions which may be claimed. By way of example, “computer readable storage medium” is understood to be defined as only non-transitory storage media.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the disclosed technology.

I claim:

1. A method of authenticating a user, comprising the steps of:
receiving a request to access data via a first network protocol from a first physical hardware device;
sending a challenge question via said first network protocol to said first physical hardware device;
sending a request to answer said challenge question, without sending said challenge question, via a second network protocol to a second physical hardware device;
receiving said answer to said challenge question via said second network protocol from said second physical hardware device;
granting access to said data to said first physical hardware device.

2. The method of authenticating a user of claim 1, wherein said first network protocol is hypertext transport protocol and said second network protocol is short message service.

3. The method of authenticating a user of claim 2, wherein said request to access data is sent from a web browser and said answer to said challenge question is received from a phone.

4. A method of authenticating a user, comprising the steps of:
receiving a request to access data via a first network protocol from a first physical hardware device;
sending a challenge question via a second network protocol to a second physical hardware device;
sending a request to answer said challenge question, without sending said challenge question, via said second network protocol to a second physical hardware device;
receiving said answer to said challenge question via said first network protocol from said first physical hardware device;
granting access to said data to said first physical hardware device.

5. The method of authenticating a user of claim 1, wherein said first network protocol is hypertext transport protocol and said second network protocol is short message service.

6. The method of authenticating a user of claim 2, wherein said request to access data is sent from a web browser and said answer to said challenge question is received from a phone.

7. A system for authenticating a user, comprising the steps of:
communicating with said user's first hardware device via a first network node using a first network protocol;
communicating with said user's second hardware device via a second network node using a second network protocol;
receiving from said first hardware device a request to access content;
sending a challenge question to said user via one of said first network node or said second network node;
receiving an answer to said challenge question via a network node other than said network node where said challenge question was sent;
sending data to said first hardware device including said content.

8. The system of authenticating a user of claim 7, wherein said challenge question is sent via said first network node and said answer is received from said second network node.

9. The system of authenticating a user of claim 7, wherein said challenge question is sent via said second network node and said answer is received from said first network node.

10. The system of claim 7, wherein said first hardware device and said second hardware device are two different physical devices in different housings.

11. The system of claim 7, wherein said first hardware device and said second hardware device are different antennas in a same housing.

12. The system of claim 11, wherein said first network protocol and said first network node are associated with a cellular network and a second network node and a second network protocol are associated with a Wi-Fi network.

13. The system of claim 7, wherein one of said first or said second network protocols is designed for use in a web browser and the other of said second or said first network protocols is designed for sending and receiving text messages.

14. The system of claim 13, wherein said first or said second network protocol designed for use in said web browser is a version of hypertext transport protocol and said second or said first said network protocol designed for said sending and said receiving of said text messages is short message service.

15. The system of claim 7, wherein said answer is received only from a device which has not received said challenge question.
